(19) United States
(12) Patent Application Publication
(10) Pub. No.: US 2006/0093424 A1
(43) Pub. Date: May 4, 2006

(54) Multi-chamber applicator

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/977,928

(22) Filed: Oct. 30, 2004

(51) Int. Cl. B43K 19/00

(52) U.S. Cl. 401/49

(57) ABSTRACT

A compact disposable single-dose applicator that may be used to apply one or more substances such as adhesives and dental compounds. The multi-chamber applicator comprises of a container, a compression means, and an applicator. The container comprises one or more chambers with a passage positioned between the chambers that will accept an applicator inserted into the passage. Each chamber has one or more fluid flow paths leading from the chamber to the passage. The compression means comprises of one or more elongated protrusions that are connected at their base to a compression plate. As the compression means is urged into the chambers, the substances in the chambers will be forced through the fluid flow path into the passage and out through an applicator inserted in the passage. The applicator also functions as an opening means to enable the shipment and storage of the multi-chamber applicator in a sealed state and enable opening of the multi-chamber applicator for access to its contents.

### BACKGROUND-FIELD OF INVENTION

The present invention relates generally to an applicator with an enclosed substance such as a fluid. More specifically, the present invention relates to a compact single-dose applicator with one or more chambers that may contain one or more substances such as a liquid in the chambers that may be compressed to force the contents out through an applicator.

### BACKGROUND-DESCRIPTION OF RELATED ART

A common applicator design for applying adhesives and dental compounds generally comprises of one or more large plastic tubes containing one or more substances to be applied. The large plastic tubes are generally of a size that is sufficient to contain sufficient substances for multiple applications. An applicator tip may be built into an end of the plastic tube or a separate detachable applicator tip may be utilized to apply the substances in the plastic tubes. A compression device is used to push and force the contents of the plastic tube out through the applicator tip. The compression device may be a simple elongated plunger that is inserted into the plastic tube. In this design, the applicator resembles a conventional syringe design. The user uses the fingers to grasp a lip at one end of the plastic tube and pushes the elongated plunger into the plastic tube with the thumb of the same hand. As the elongated plunger is pushed into the plastic tube, the substance in the plastic tube will be extracted through the other end of the plastic tube through the applicator tip. In another design, the compression device is a mechanism with one or more plungers that will extend into the plastic tubes when a trigger mechanism is repeatedly compressed to activate a ratchet mechanism to move the plungers into the plastic tubes in small increments. The compression device of this design is complex and expensive and is subject to breakage of its trigger mechanism and ratchet mechanism.

With the conventional designs, the applicator is bulky and difficult to apply to small areas due to its bulk. Furthermore, the applicator according the conventional design is difficult to use due to its inherent length and size. The applicator itself will tend to obstruct the user's view of the application site. In addition, the conventional designs generally are complicated and expensive to manufacture. Most conventional designs attempt to minimize the cost per use by using larger plastic tubes which contain large quantity of substances for multiple applications. Thus, only the applicator tip of the applicator needs to be disposed of between each application. The plastic tubes and the compression device can be used multiple times before disposal. However, some substances will not allow such multiple applications if a long time period elapse between applications. In this case, the remaining substances will have to be disposed of resulting in waste. This waste may be quite substantial and expensive, particular for some dental compounds.

### SUMMARY OF THE INVENTION

The present invention is a compact single-dose applicator that may be used to apply one or more substances such as adhesives and dental compounds. The multi-chamber applicator comprises of a container, a compression means, and an applicator.

The container comprises one or more chambers. A passage is positioned between the two chambers that will accept an applicator inserted into the passage. Each chamber has one or more fluid flow paths leading from the chamber to the passage. The compression means comprises of one or more elongated protrusions that are connected at their base to a compression plate. As the compression means is urged into the chambers, the substances in the chambers will be forced through the fluid flow paths into the passage and out through an applicator inserted in the passage. The applicator also functions as an opening means to enable the shipment and storage of the multi-chamber applicator in a sealed state and enable opening of the multi-chamber applicator for access to its contents.

The multi-chamber applicator is a compact disposable single-dose applicator that can be manufactured economically and does not obstruct the user's view of the application site. Furthermore, the multi-chamber applicator minimizes or eliminates waste entirely. The reduction or elimination of waste of expensive substances such as dental compounds greatly reduces the overall cost of the use of the multi-chamber applicator.

### BRIEF DESCRIPTION OF THE DRAWINGS

FIG. 1 shows the preferred embodiment of the multi-chamber applicator.

FIG. 2 shows the cross sectional view of the preferred embodiment of the multi-chamber applicator shown in FIG. 1.

FIG. 3 shows another embodiment of the multi-chamber applicator.

FIG. 4 shows another embodiment of the multi-chamber applicator.

FIG. 5 shows another embodiment of the multi-chamber applicator.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

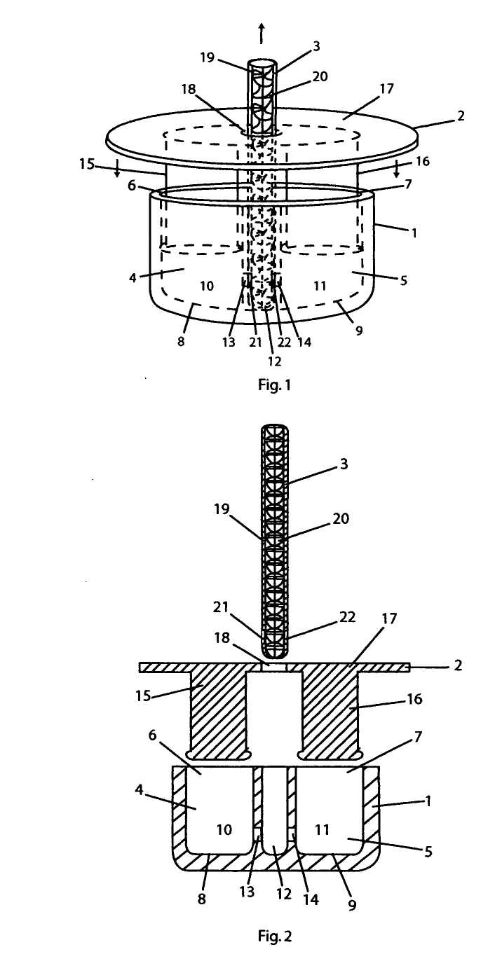

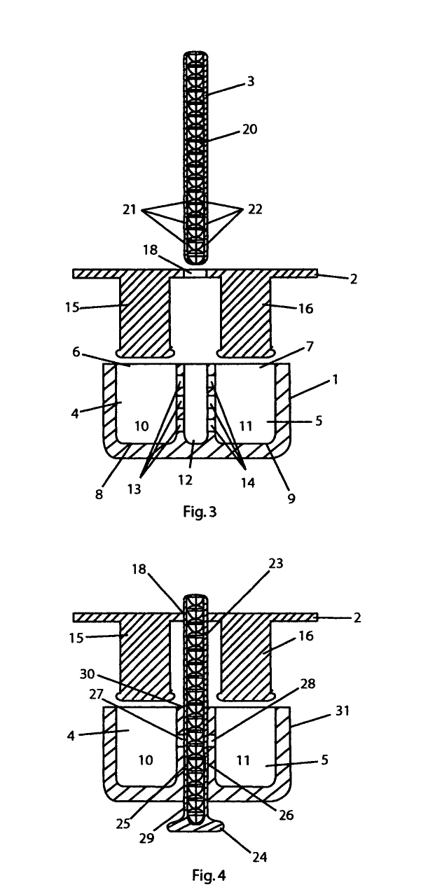

FIGS. 1, 2, and 3 show the preferred embodiment of the multi-chamber applicator. The multi-chamber applicator comprises of a container 1, a compression means 2, and an applicator 3. The container 1 comprises one or more chambers 4, 5, each with an open end 6, 7 and a sealed end 8, 9, that enclose one or more substances 10, 11 such as a liquid, a cream, or a viscous substance. In the preferred embodiment, the container 1 has two small chambers 4, 5 each containing a different viscous substance 10, 11 to be mixed before application. A passage 12 is positioned between the two chambers 4, 5 that will accept an applicator 3 inserted into the passage 12. Each chamber 4, 5 has one or more fluid flow paths 13, 14 from the chamber 4, 5 to the passage 12. In the preferred embodiment, the fluid flow paths 13, 14 are positioned near the sealed ends 8, 9 of the chambers 4, 5. The one or more fluid flow paths 13, 14 may also be positioned anywhere along the separation between the chambers 4, 5 and the passage 12. The fluid flow paths 13, 14 may be simply openings that lead from each chamber 4, 5 into the passage 12.

The compression means 2 comprises of one or more elongated protrusions 15, 16 affixed to a compression plate 17. In the preferred embodiment, the compression means 2 comprises of two elongated protrusions 15, 16 that are connected at their bases to a compression plate 17. The elongated protrusions 15, 16 have profiles that match the profiles of the chambers 4, 5 in the container 1. The length of the protrusions 15, 16 is predetermined so that they will reach completely to the sealed ends 8, 9 of the chambers 4, 5 in the container 1 when the compression means 2 is compressed toward the chambers 4, 5. The compression plate 17 has an opening 18 between the two protrusions 15, 16 such that when the protrusions 15, 16 are placed through the open ends 6, 7 of the chambers 4, 5 in the container 1, the opening 18 will align with the passage 12 in the container 1.

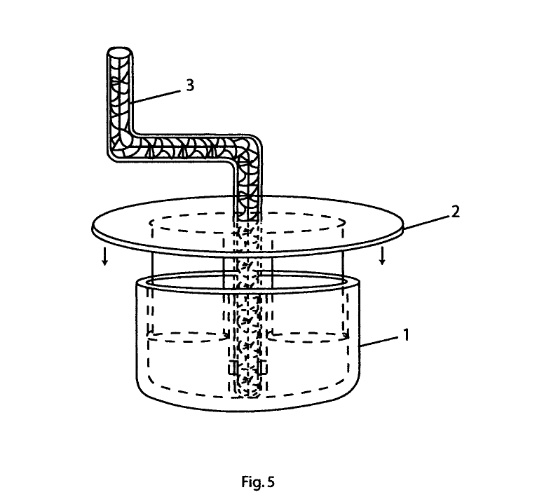

The applicator 3 has a cross-sectional profile that match the cross-sectional profile of the passage 12 in the container 1 such that it can be inserted into the passage 12 through the opening 18 in the compression plate 17. In the preferred embodiment, the applicator 3 comprises of a hollow tube 19 with an outside diameter approximately that of the inside diameter of the passage 12 in the container 1. Also in the preferred embodiment, within the hollow tube 19, is affixed a mixing means 20 to enable the mixing of the two substances 10, 11 in the container 1 as they are forced through the hollow tube 19. The mixing means 20 may be an intermittent spiraling surface, similar to a screw with an intermittent thread, that will allow commingling and mixing of the two substances 10, 11 as they pass through the hollow tube 19. The applicator 3 may also be made of a deformable or bendable material that will retain its bent shape such that it may be bent to various configurations and angles to reach the desired location for application, as shown in FIG. 5.

In one embodiment, the applicator 3 has openings 21, 22 that correspond to the openings 13, 14 in the chambers 4, 5 such that by rotating or sliding the applicator 3 within the passage 12, the openings 21, 22 in the applicator 3 can be aligned with the openings 13, 14 in the chambers 4, 5 to allow extraction of the substances 10, 11 in the chambers 4, 5. Prior to the multi-chamber applicator is being used, the applicator 3 is positioned such that the openings 21, 22 in the applicator 3 are not aligned with the openings 13, 14 in the chambers 4, 5 thereby sealing the chambers 4, 5 prior to use. One or more sets of protrusions and indentations may be provided between the applicator 3 and the wall of the passage 12 such that a positive stop may be felt when the applicator 3 is rotated or moved thereby aligning the openings 21, 22 in the applicator 3 with the openings 13, 14 in the chambers 4, 5. In one embodiment, the end of the applicator 3 that is inserted into the passage 12 may also be sealed. In yet another embodiment, the applicator 3 has two open ends and is slidable within the passage 12 such that when it is inserted into the passage 12, the openings 13, 14 in the chambers 4, 5 will be blocked by the applicator 3. When the applicator 3 is pulled or pushed away from the openings 13, 14 in the chambers 4, 5 such that the openings 13, 14 will be exposed to the open end of the applicator 3, the substances 10, 11 in the chambers 4, 5 can be extracted through the openings 13, 14 in the chambers 4, 5 through the open end of the applicator 3 and out through the other end of the applicator 3.

The compression means 2 is placed over the container 1 with the two protrusions 15, 16 inserted into the two chambers 4, 5 in the container 1. In one embodiment, the applicator 3 is inserted through the opening 18 in the compression plate 17 into the passage 12 between the chambers 4, 5. In another embodiment, shown in FIG. 4, the applicator 23 with a sealed end 24 and with one or more openings 25, 26 that correspond to the openings 27, 28 in the chambers 4, 5 is inserted through an open end 29 of the passage 30 near the sealed end of the chambers 4, 5 and extends through the passage 30 and out through the opening 18 in the compression plate 17. The multi-chamber applicator in this embodiment may be manufactured with the bottom 24 of the applicator 23 extended out of the bottom of the container 31 such that the openings 25, 26 in the applicator 23 and the openings 27, 28 in the chambers 4, 5 are not aligned, thereby sealing the substances 10, 11 in the chambers 4, 5. Just prior to use, the applicator 23 is pushed in to align the openings and allow extraction of the substances 10, 11 in the chambers 4, 5. One or more sets of protrusions and indentations may be provided between the applicator 23 and the wall of the passage 30 such that a positive stop may be felt when the applicator 23 is moved longitudinally in the passage 30 thereby aligning the openings 25, 26 in the applicator 23 with the openings 27, 28 in the chambers 4, 5. When the compression means 2 is forced towards the bottom of the chambers 4, 5, such as by an user's fingers and palm, the protrusions 15, 16 in the compression means 2 will simultaneously force the two substances 10, 11 in the two chambers 4, 5 in the container 31 through the fluid flow paths 27, 28 into the passage 30 and out through the applicator 23. The two substances 10, 11 will commingle and mix within the applicator 23 as they pass through the mixing means 20 in the applicator 23.

The multi-chamber applicator may be used to apply dual component mixtures such as certain adhesives and filling compounds that require the two components to be stored separately until they are to be applied. Just prior to application, the components will have to be mixed together and then applied to desired location. The multi-chamber applicator is compact and may be economically manufactured as a single-dose applicator that is disposed after each use.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A multi-chamber applicator comprising:
a container;
a compression means; and
an applicator;
wherein said container encloses one or more substances.

2. A multi-chamber applicator as in claim 1, wherein said container comprises one or more chambers each with an open end and a sealed end.

3. A multi-chamber applicator as in claim 2, wherein said container comprises two small chambers with a viscous substance contained in one or both of said chambers with a passage positioned between said two chambers and each chamber has one or more fluid flow paths from said chamber to said passage.

4. A multi-chamber applicator as in claim 4, wherein said fluid flow paths are positioned near the sealed ends of said chambers.

5. A multi-chamber applicator as in claim 3, wherein said compression means comprises one or more elongated protrusions affixed to a compression plate.

6. A multi-chamber applicator as in claim 5, wherein said compression means comprises of two elongated protrusions that are affixed at their bases to a compression plate.

7. A multi-chamber applicator as in claim 6, wherein the length of said protrusions will reach completely to a sealed end of said chambers in said container when said compression means is urged toward said chambers.

8. A multi-chamber applicator as in claim 7, wherein said compression plate has an opening between said two protrusions such that when said protrusions are placed in said chambers in said container said opening will align with said passage in said container.

9. A multi-chamber applicator as in claim 5, wherein said applicator comprises of a hollow tube.

10. A multi-chamber applicator as in claim 9, wherein a mixing means is affixed within said hollow tube.

11. A multi-chamber applicator as in claim 10, wherein said mixing means is an intermittent spiraling surface.

12. A multi-chamber applicator as in claim 9, wherein said applicator is made of a deformable or bendable material that will retain its bent shape after it is bent.

13. A multi-chamber applicator as in claim 3, wherein said applicator has one or more openings that corresponds to said one or more fluid flow paths from said chamber to said passage wherein the applicator may be rotated or slide along said passage to align said one or more openings in said applicator with said one or more fluid flow paths.

14. A multi-chamber applicator as in claim 13, wherein one or more sets of protrusions and indentations are provided on said applicator and said passage to enable positive stops when said applicator is moved with respect to said passage.

15. A multi-chamber applicator as in claim 9, wherein said applicator has a seal end.

16. A multi-chamber applicator as in claim 9, wherein said applicator has an open end.

17. A multi-chamber applicator comprising:
a container comprising two small chambers with a viscous substance contained in one or both of said chambers with a passage positioned between said two chambers and each chamber has one or more fluid flow paths positioned near a sealed end of said chambers;
a compression means comprising two elongated protrusions wherein the length of said protrusions will reach completely to a sealed end of said chambers in said container when said compression means is urged toward said chambers and wherein said elongated protrusions are affixed at their bases to a compression plate wherein said compression plate has an opening between said two protrusions such that when said protrusions are placed in said chambers in said container said opening will align with said passage in said container; and
an applicator comprising a hollow tube with one or more openings that corresponds to said one or more fluid flow paths from said chamber to said passage wherein the applicator may be rotated or slide along said passage to align said one or more openings in said applicator with said one or more fluid flow paths and with a mixing means affixed within said hollow tube.

18. A multi-chamber applicator as in claim 17, wherein one or more sets of protrusions and indentations are provided on said applicator and said passage to enable positive stops when said applicator is moved with respect to said passage

19. A multi-chamber applicator as in claim 17, wherein said applicator has a sealed end.

20. A multi-chamber applicator as in claim 17, wherein said passage passes through said container.
